(19) United States
(12) Patent Application Publication
(10) Pub. No.: US 2008/0117397 A1
(43) Pub. Date: May 22, 2008

(54) OPTICAL DEVICES HAVING KINEMTAIC COMPONENTS

(75) Inventors: Jochen Weber, Heidenheim (DE); Klaus Rief, Aalen-Oberalfingen (DE); Claudia Matano, Heidenheim (DE); Benjamin Sigel, Aalen (DE); Joachim Siegel, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/935,719

(22) Filed: Nov. 6, 2007

(30) Foreign Application Priority Data
Nov. 7, 2006 (DE) 10 2006 052 688.0

(51) Int. Cl. G03B 27/42

(52) U.S. Cl. 355/53

(57) ABSTRACT

Optical devices that have at least one optical element and a plurality of kinematic components are disclosed. The number m of the kinematic components of one type exceed the number n of degrees of freedom in which the optical element can be manipulated. At least one of the n degrees of freedom can be x-displacement, y-displacement, z-displacement or tilt.

### CROSS-REFERENCE TO RELATED APPLICATION

This application claims priority under 35 U.S.C. §119 to German patent application serial number 10 2006 052 688.0, filed Nov. 7, 2006, which is hereby incorporated by reference.

### FIELD

The disclosure relates to optical devices that have at least one optical element and kinematic components to manipulate and/or determine the position of the at least one optical element. The kinematic components can be, for example, actuators and/or sensors. The disclosure also relates to related systems (e.g., projection exposure apparatuses for semiconductor lithography) and methods (e.g., semiconductor lithography methods).

### BACKGROUND

Manipulable optical elements are a substantial component of a multiplicity of optical devices—including very complex ones.

### SUMMARY

In one aspect, the disclosure features an optical device that includes at least one optical element and a plurality of kinematic components. The at least one optical device can be manipulated in n degrees of freedom. The plurality of kinematic components is configured to manipulate and/or determine a position of the at least one optical element. The plurality of kinematic components includes a number m of a first type, and m is greater than n. At least one of the n degrees of freedom is x-displacement, y-displacement, z-displacement or tilt.

In another aspect, the disclosure features a projection exposure machine for semiconductor lithography. The projection exposure machine includes an optical device. The optical device includes at least one optical element and a plurality of kinematic components. The at least one optical element can be manipulated in n degrees of freedom. The plurality of kinematic components configured to manipulate and/or determine a position of the at least one optical element. The plurality of kinematic components includes a number m of a first type, and m is greater than n. At least one of the n degrees of freedom is x-displacement, y-displacement, z-displacement or tilt.

In some embodiments, the disclosure provides an optical device which has kinematic components, where the device exhibits a functionality of increased robustness with respect to the failure of individual kinematic components.

In general, the optical device has at least one optical element, for example a lens and/or a mirror, arranged in a mount. A plurality of kinematic components can be provided to manipulate and/or determine the position of the optical element. The kinematic components may thus be classified into the varieties of “actuators” or “sensors”. The number m of the kinematic components of at least one sort can exceed the number of the degrees of freedom n in which the optical element can be manipulated. In other words, two or more kinematic components of one sort can be provided for at least one degree of freedom. Optionally, more than one kinematic component is provided for each of the possible degrees of freedom, specifically movement in the x, y and z directions and tilting. This can help ensure that, for example, even upon the failure of an actuator it is still possible to manipulate the optical element and the functionality of the optical device is not impaired to such an extent that complete dismantling is required to ensure the functionality.

In certain embodiments, a point of action on the optical element is assigned at least two kinematic components of one sort. It can be ensured in this way that even upon failure of one of the kinematic components at the respective point of action, it is still possible to manipulate and/or to determine the position of the optical element—if appropriate with restrictions.

Optionally, at least one first kinematic component is arranged with reference to a further kinematic component in such a way that upon activation, in particular upon a movement of the first kinematic component, the further kinematic component is also activated, in particular is also moved. This can be achieved, for example, when the kinematic components are piezoactuators which are also arranged one above another in their direction of action as stacks. The particular advantage of the use of piezoactuators is in this case in that the actuators can be used in a known way as sensors, such that it is possible to achieve a double functionality with the advantages of saving installation space and costs. Upon failure of one of the piezoactuators, the stacked arrangement still provides a functionality—even if also somewhat restricted—of the entire arrangement to the effect that it is still possible as before to implement a movement by driving the remaining functioning actuators, even if there is a need in some cases to accept a restriction of the maximum range of movement.

Of course, it is also possible to conceive as actuators all other types of actuators, in particular Lorentz actuators, spindle drives or hydraulic or pneumatic pressure cylinders.

In some embodiments, the first and the further kinematic components are the individual piezostacks of a so-called piezocrawler. A piezocrawler is a linear arrangement of interconnected piezoactuators or piezostacks which move along by alternating activation of the piezoactuators in the manner of a caterpillar on a surface. Examples of such components are to be found in U.S. Pat. No. 6,150,750 B2 and in the German Laid-Open Specification DE 102 25 266 A1. In this case, the piezocrawler can be permanently connected to an optical element and can, for example, move along on a surface of a housing together with the optical element and in this way effect manipulation of the optical element. Generally speaking, in this case the failure of an individual actuator or piezostack will lead to a reduction in the maximum speed of movement or to a reduction in the maximum force which can be exerted on the piezocrawler. The advantage of the use of the piezocrawler can reside in the fact that the failure of an individual actuator or piezostack does not lead to a reduction in the maximum range of movement.

In certain embodiments, at least the first kinematic component is arranged with reference to the further kinematic component in such a way that upon activation of the first kinematic component the further kinematic component is not activated, in particular not also moved. In other words, the two kinematic components are connected in parallel with regard to their point of action.

A field of application for the use of the abovedescribed device and variants thereof consists in their being used in a projection exposure machine for semiconductor lithography. The optical systems used in the projection exposure machines are distinguished, on the one hand, in that they exhibit an enormous complexity. Moreover, manipulable optical elements are widespread in such machines, and so it is precisely in this application that there is an increased requirement for a sensor system and actuator system that are robust and failsafe.

### BRIEF DESCRIPTION OF THE DRAWINGS

Exemplary embodiments of the disclosure are explained in more detail below with the aid of three figures, in which:

FIG. 1 shows a parallel arrangement of the kinematic components;

FIG. 2 shows a series arrangement of the kinematic components; and

FIG. 3 illustrates a projection exposure machine.

### DETAILED DESCRIPTION

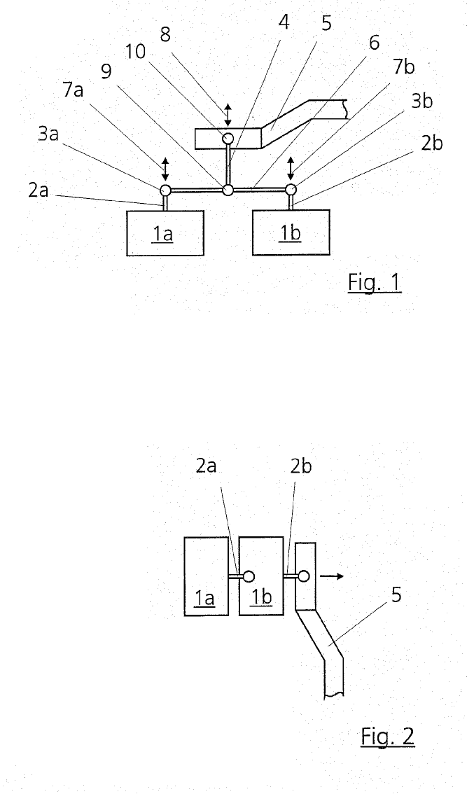

FIG. 1 shows a parallel arrangement of the kinematic components designed as piezoactuators 1a and 1b. In this case, the levers 2a and 2b of the two piezoactuators 1a and 1b are interconnected via the articulations 3a and 3b and the connecting rod 6. Upon activation of the piezoactuator 1a, the lever 2a moves in the direction of the double arrow 7a. In the case when the piezoactuator 1b remains inactive during activation of the piezoactuator 1a, the connecting rod 6 is moved about the articulation 3b. As a result, the optical element 5 connected to the connecting rod 6 via the articulations 9 and 10 and the control lever 4 is moved in the direction of the double arrow 8. A corresponding statement holds for activation of the piezoactuator 1b in conjunction with the lever 2b in the direction of the double arrow 7b in the case of an inactive piezoactuator 1a. The result here is a movement of the connecting rod 6 about the articulation 3a.

It is immediately clear from the figure that twice the travel path can be achieved by comparison with the case outlined above given a simultaneous activation of the two piezoactuators 1a and 1b. Consequently, there are two alternatives for implementing the embodiment illustrated in FIG. 1: firstly, the arrangement can be designed from the outset such that the desired travel path of the optical element 5 can be achieved by activating only one of the two piezoactuators 1a and 1b. In this case, in the event of failure of one of the two actuators the actuator still functioning can be driven after detection of the failure; this can be performed, for example, via a multiplexer. It is likewise conceivable to design the arrangement in such a way that the desired travel path of the optical element 5 is achieved by virtue of the fact that the two piezoactuators 1a and 1b are simultaneously driven; a travel path twice that of the first case outlined can be implemented in this way. This would still make a functioning actuator available after the failure of one of the two piezoactuators 1a or 1b, and so the arrangement as a whole would still exhibit a functionality—even if a restricted one.

FIG. 2 shows an arrangement of the two piezoactuators 1a and 1b on one another in the manner of a series connection. In this case, the piezoactuator 1b is connected to the piezoactuator 1a via the lever 2a, that is to say upon activation of the piezoactuator 1a, the piezoactuator 1b also moves and acts via the lever 2b on the optical element 5. Of course, the two piezoactuators 1a and 1b can be driven alternatively; in this case, the respectively inactive piezo-actuator acts as a passive lever part.

For the configurations shown in the two figures described above, it is advantageous when the arrangement is designed in such a way that upon failure of one of the piezoactuators 1a and 1b in an arbitrary position, the optical element 5 can still be moved in the range provided. If appropriate, after the failure of one of the two piezoactuators 1a and 1b, the range of movement of the optical element 5 can also be adapted by virtue of the fact that an effectively accessible adjusting device (not illustrated) is provided, by which it is possible to undertake a variation in the range of movement of the optical element 5.

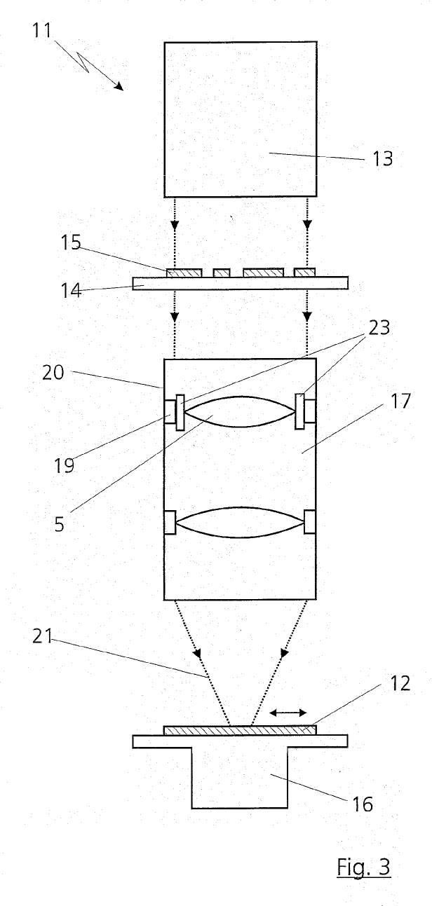

FIG. 3 illustrates a projection exposure machine 11 for microlithography which is equipped with kinematic components in accordance with the disclosure. The machine serves for exposing structures onto a substrate coated with photo-sensitive materials and which generally consists predominantly of silicon and is designated as a wafer 12, the purpose being to produce semiconductor components such as, for example, computer chips.

The projection exposure machine 11 in this case substantially comprises an illuminating device 13, a device 14 for holding and exactly positioning a mask provided with a grid-like structure, a so-called reticle 15, by which the later structures are determined on the wafer 12, a device 16 for holding, moving and exactly positioning just this wafer 12, and an imaging device, specifically a projection objective 17 having a number of optical elements 5 which are supported via mounts 19 in an objective housing 20 of the projection objective 17. The basic functional principle provides in this case that the structures inserted into the reticle 15 are imaged onto the wafer 12 in a reduced fashion.

After exposure has been performed, the wafer 12 is moved on in the direction of the arrow such that a multiplicity of individual fields, respectively having the structure prescribed by the reticle 15, are exposed on the same wafer 12. Because of the stepwise feed movement of the wafer 12 in the projection exposure machine 11, the latter is frequently also designated as a stepper.

The illuminating device 13 provides a projection beam 21 required for imaging the reticle 15 on the wafer 12. A laser or the like can be used as source for this radiation. The radiation is shaped in the illuminating device 13 via optical elements such that, upon striking the reticle 15, the projection beam 21 has the desired properties with regard to diameter, polarization, shape of the wavefront and the like.

An image of the reticle 15 is produced via the projection beam 21 and transferred onto the wafer 12 by the projection objective 17 in an appropriately reduced fashion, as has already been explained above. The projection objective 17 has a multiplicity of individual refractive, diffractive and/or reflective optical elements 5 such as, for example, lenses, mirrors, prisms, terminal plates and the like.

In the present example, the optical element 5 is connected to the mount 19 via a so-called piezocrawler 23. In this case, the piezocrawler 23 is permanently connected to the optical element 5 and moves on the surface of the mount 19 together with the optical element 5 in the direction of the optical axis of the projection objective 17.

It is, of course, possible to combine the concepts outlined in any desired way so as to increase the reliability of the optical devices, or else to adapt them to particular requirements. Moreover, it is also possible to conceive applying the concept outlined straight away beyond the field of kinematic components, in particular also for thermal manipulator arrangements, for example.

Other embodiments are in the claims.

What is claimed is:

1. An optical device, comprising:
at least one optical element which can be manipulated in n degrees of freedom; and
a plurality of kinematic components configured to manipulate and/or determine a position of the at least one optical element,
wherein:
the plurality of kinematic components includes a number m of a first type;
m is greater than n; and
at least one of the n degrees of freedom comprises a degree of freedom selected from the group consisting of x-displacement, y-displacement, z-displacement and tilt.

2. The optical device according to claim 1, wherein at least two kinematic components of the first type are present for at least one of the n degrees of freedom.

3. The optical device according to claim 1, wherein at least two kinematic components of the first type are present for each of the n degrees of freedom.

4. The optical device according to claim 1, wherein at least two kinematic components are assigned to a point of action on the at least one optical element.

5. The optical device according to claim 4, wherein for a specific degree of freedom at least one first kinematic component is arranged in relation to a further kinematic component in such a way that upon activation of the first kinematic component the further kinematic component is likewise activated.

6. The optical device according to claim 1, wherein at least one kinematic component is an actuator.

7. The optical device according to claim 5, wherein the first and the further kinematic components are individual piezostacks of a piezocrawler.

8. The optical device according to claim 4, wherein for a specific degree of freedom at least one first kinematic component is arranged in relation to a further kinematic component in such a way that upon activation of the first kinematic component the further kinematic component is not activated.

9. The optical device according to claim 1, wherein at least one kinematic component is a sensor.

10. A projection exposure machine, comprising:
an optical device, comprising:
at least one optical element which can be manipulated in n degrees of freedom; and
a plurality of kinematic components configured to manipulate and/or determine a position of the at least one optical element,
wherein:
the plurality of kinematic components includes a number m of a first type;
m is greater than n;
at least one of the n degrees of freedom comprises a degree of freedom selected from the group consisting of x-displacement, y-displacement, z-displacement and tilt; and
the projection exposure machine is a projection exposure machine for semiconductor lithography.

11. The projection exposure machine according to claim 10, wherein at least two kinematic components of the first type are present for at least one of the n degrees of freedom.

12. The projection exposure machine according to claim 10, wherein at least two kinematic components of the first type are present for each of the n degrees of freedom.

13. The projection exposure machine according to claim 10, wherein at least two kinematic components are assigned to a point of action on the at least one optical element.

14. The projection exposure machine according to claim 13, wherein for a specific degree of freedom at least one first kinematic component is arranged in relation to a further kinematic component in such a way that upon activation of the first kinematic component the further kinematic component is likewise activated.

15. The projection exposure machine according to claim 10, wherein at least one kinematic component is an actuator.

16. The projection exposure machine according to claim 14, wherein the first and the further kinematic components are individual piezostacks of a piezocrawler.

17. The projection exposure machine according to claim 13, wherein for a specific degree of freedom at least one first kinematic component is arranged in relation to a further kinematic component in such a way that upon activation of the first kinematic component the further kinematic component is not activated.

18. The projection exposure machine according to claim 10, wherein at least one kinematic component is a sensor.
